(19) United States
(12) Patent Application Publication
(10) Pub. No.: US 2009/0211598 A1
(43) Pub. Date: Aug. 27, 2009

(54) Tire shine unit and method of using same

(76) Inventors: Brent McCurdy, Bryn Athyn, PA (US); Michael V. Maurizi, Bristol, PA (US)

Correspondence Address: Gibbons PC, 18th & Arch Streets, 1700 Two Logan Square, Philadelphia, PA, 19103-2769, US

(21) Appl. No.: 12/217,960

(22) Filed: Jul. 10, 2008

Related U.S. Application Data
(60) Provisional application No. 61/067,099, filed on Feb. 25, 2008.

(51) Int. Cl. B60S 3/04; B08B 3/02; B08B 1/00

(52) U.S. Cl. 134/6; 134/123; 15/97.3; 222/630

(57) ABSTRACT

Disclosed is a unit for applying a fluid material to a surface of a vehicle. The unit includes a body, at least one reservoir for holding a fluid material, at least one sprayer connected to the reservoir via a hose, an optional applicator pad for spreading, wiping or buffing the fluid material on a surface of a vehicle to which the fluid material is applied, and a pressure source for transferring the fluid material from the at least one reservoir to the at least one sprayer. The unit further includes a control system for activating the pressure source upon receipt of a signal. A method for using the above mentioned unit is also described.

### PRIORITY INFORMATION

This application claims the benefit of U.S. Provisional Application Ser. No. 61/067,099, entitled “Tire Shine Unit And Method Of Using Same”, filed Feb. 25, 2008, the disclosure of which is incorporated herein as if set forth in its entirety.

### FIELD OF THE INVENTION

The instant invention relates to the field of car wash products, and in particular to devices and systems for applying products to tire surfaces at various locations within a car wash facility.

### BACKGROUND OF THE INVENTION

As may typically be found at car wash facilities, tire shine services are provided either inside tunnel wash systems, or manually outside the tunnel. While each of these systems provide value to the car wash facility, they each have their own shortcomings.

For example, the services provided inside the tunnel have value in that they are fully automated, and therefore do not require additional manual labor. However, while the results from these automated systems are relatively consistent, they are completely impractical outside of a tunnel application, such as at a self service car wash, a convenience store car wash or at a self service automated car wash, because the simply are too large and would require extensive equipment to get a car into position to apply inside of a typical car wash.

Manual tire shine services, which are performed outside and subsequent to the tunnel wash, fall into two types—consumer applied, which is messy on their hands and requires the use of a sponge, or manually applied by a car wash employee. However, this attention to detail comes with a price, and not only will the car owner be asked to pay a higher fee, those elevated expectations may create more disgruntled customers, and therefore increase time and costs handling quality control and customer service issues for the car wash facility. Additionally, labor must be present for this application, which is not a practical feature at self service washes or other automatic car washes.

Therefore, a need exists to provide an automated tire shine unit which can be applied by a consumer and/or employee of the wash that is easy to use, and that still maintains a high quality product of a manual tire shine.

### SUMMARY OF THE INVENTION

A unit for applying a fluid material to a surface of a vehicle is described. The unit includes a body, at least one reservoir for holding a fluid material, at least one sprayer connected to the reservoir via a hose, an optional applicator pad for spreading, wiping or buffing the fluid material on a surface of a vehicle tire to which the fluid material is applied, and a pressure source for transferring the fluid material from the at least one reservoir to the at least one sprayer. The unit further includes a control system for activating the pressure source upon receipt of a signal. A method for using the above mentioned unit is also described.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary unit body, according to an aspect of the present invention;

FIG. 2 illustrates an exemplary pressure source and control system, according to an aspect of the present invention;

FIG. 3A illustrates an exemplary sprayer and applicator, according to an aspect of the present invention;

FIG. 3B illustrates another exemplary sprayer, according to an aspect of the present invention;

FIG. 4 illustrates a close up of an exemplary applicator, according to an aspect of the present invention;

FIG. 5 illustrates an exemplary sprayer when applying the fluid material to the surface of a tire, according to an aspect of the present invention; and

FIG. 6 illustrates an exemplary sprayer and applicator when applying the fluid material to the surface of a tire, according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical car wash material application systems and the methods of manufacturing and using the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention may generally be described as a self-contained application system for applying different types of materials to surfaces of a vehicle, particularly those materials which require a spreading, wiping or buffing step subsequent to the delivery of a fluid material or component to the vehicle surface. For example, the present invention may be used for applying tire shine products to the tire sidewalls, a water repellant coating to a windshield, a cleaning solution for a leather interior or a protectant coating to a paint finish. The present invention may be used with any liquid based or substantially fluid material suitable for delivery through a hose and spraying onto a vehicle surface.

In one embodiment, the present invention may provide a partially automated method of applying tire surface treatment products to a tire sidewall while minimizing errant spray of the fluid materials on the tire rim. Because the present invention may allow the application step to be controlled by a person, the same unit may be used for all vehicle types and tire sizes, such as compact passenger vehicle tires, or larger, industrial truck tires.

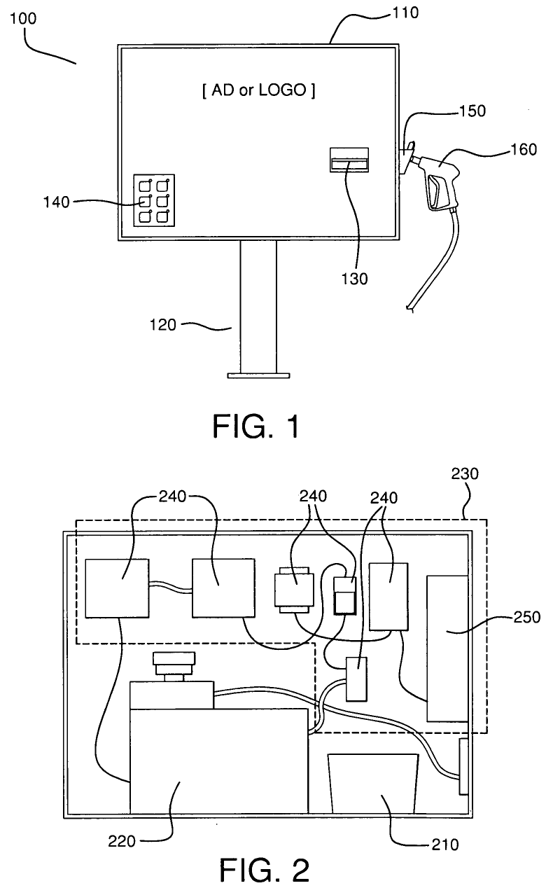

According to an aspect of the present invention and as shown generally in FIG. 1, the unit 100 may include a body or housing, which may further include a cabinet-like portion 110 and supporting mechanism 120. The cabinet-like portion 110 may be any sort of housing or framework that holds or supports other components of the present invention. On the front surface of cabinet portion 110 may be a coin or bill collector or credit card reader 130, as well as a service item menu 140. Additional space may be used for placement of logos, advertisements or any other informational materials as desired. Unit 100 may also have one or more hooks, brackets or other mounting devices 150 attached to or form part of the exterior surface of the body, for holding the sprayer, and/or applicator pad 160 when not in use. Additional hooks 150 may also be used for storing the hosing, tubing or power lines associated with the sprayer and applicator pad 160.

Supporting mechanism 120 may be one or more legs resting on the ground or floor surface, or it may be a hanging mechanism, such that cabinet portion 110 may be supported on a wall, for example. In alternative embodiments, various portions of the invention may be located in different places. For example, a portion may be located in bay, while other portions may be remotely located in an equipment room. The body may be permanently fixed at a specific location of the car wash facility, such as at a region subsequent to a car wash tunnel. Alternatively, unit 100 may be portable, in that it may be moved to various positions of the car wash facility. In one such embodiment, caster wheels may be mounted on the bottom of the one or more support legs to facilitate portability of the body. Additionally, wheel locks may be used to stabilize the unit once the location for operation is reached and a stationary unit is desired.

As shown in FIG. 1, the exterior surface of cabinet portion 110 may provide instructions for use, including the required fee and length of operating time based on the fee paid, as well as the location for insertion of the required fee. The exterior surface of the body may further provide a fluid material or product display area for identifying what materials may be dispensed or otherwise applied from the unit. The exterior surfaces of the body may also be decorated with commercial names for the material or materials for application by the present invention.

As shown in FIG. 2, within the body of unit 100 may be a reservoir 210 for holding the fluid material (which may also be the container holding a chemical when purchased); a pressure source 220 for pressurizing or depressurizing reservoir 210; a control system 230 that includes control circuitry 240 (for activating pressure source 220 upon receipt of a signal) and a coin or bill collector or credit card valildator 250 for accepting payment of a fee. These components of the present invention may be entirely contained within the body of the unit, or it may utilize external feeds, such as for electrical power, air pressure, or material solution mixes that may be supplied into the reservoir through a separate hose or tube. Alternatively, any one of these components may be located remotely from one another, provided the components are either electronically and/or fluidly connected as needed.

As identified in FIG. 2, the control system 230 includes control circuitry 240 for activating the pressure source upon receipt of a signal. In one exemplary embodiment, such a signal may be based upon receipt of a payment. For example, the unit may include a self paying vending system, such that a user may insert a designated amount of money into the unit to initiate operation. In other embodiments, a standard switch may be used, and not require any form of payment.

Control system 230 may also include coin or bill collector or credit card valildator 250 for accepting payment of a fee. This device may be a coin acceptor, bill validator, credit card reader, or any other mechanism for accepting a payment. For example, the coin acceptor may accept valid coins and provide a corresponding payment signal to an internal timer or controller (not depicted) for operating the pressure source for a designated amount of time commensurate with the amount of payment received. The bill validator may validate bills of the correct form of currency and send a corresponding payment signal to the internal timer or controller. Similarly, the credit card reader may read credit or debit cards, and upon valid payment provide a payment signal to the internal vending timer or controller. The coin acceptor and bill validator may include a mechanism for confirming that the fund inputs are valid. This may include a typical security device as may be understood by those skilled in the art, for distinguishing genuine from counterfeit units of currency.

Control system 230 may also include a menu or service selector, such as service item menu 140 illustrated in FIG. 1. The menu or service selector may indicate the fluid material or service options from which a user may choose. For example, the menu or service selector may be a set of buttons, or icons on a touch screen, corresponding to the fluid material or service selected. The fluid materials or services selectable via the menu may include all the options as described herein. According to an aspect of the present invention, the control system, upon receiving the appropriate payment, activates the menu or service selector, such that when the user makes his or her selection, a signal activates the corresponding fluid material or service.

Control system 230 may further include a display for identifying the selected material and a status of product delivery. The display may provide information such as the amount of money deposited, and the amount of time remaining that the fluid material or service will be provided before the amount of time purchased runs out, for example. Advertisements may also be provided via the display. The display may be in any format suitable for providing information to a user of the unit.

Control system 230 may also include an alert mechanism, such as a beeper, for warning the user of the unit that the application is about to end. For example, such an alert system may be set for 15, 30, 45 or 60 seconds prior to termination by the timer.

According to an aspect of the present invention, a sprayer may be connected to the reservoir via a hose or tube, and an applicator pad for spreading, wiping or buffing the fluid material on the vehicle surface may further be attached to the unit. Alternatively, the applicator pad may be removably attached to the sprayer. In other embodiments of the present invention, the unit may be designed for delivery and application of multiple fluid materials or products. In such a case, each fluid material would have its own reservoir, and optionally its own sprayer and applicator pad.

To access those components within cabinet portion 110 of the body, a drop down panel or hinged door may be used. Under all circumstances, any access door or panel to the internal components of the unit may be locked by standard locking mechanisms understood by those skilled in the art.

The unit may also be provided with a ventilation and heating/cooling system to maintain optimal functionality of the unit in all weather and temperature environments.

According to another aspect of the present invention, a pressure source may be used to deliver the fluid material from a reservoir to the sprayer via hosing or tubing, for application to the targeted vehicle surface. For example, a pump or pressurized air source may be used, such that it includes a compressor and pressure regulator that are connected to a reservoir holding a fluid material. Upon receiving a control signal, the pump or compressor may be used to transport the fluid material from the reservoir to the sprayer at the end of a hose or tube. T he pressure regulator may control the compressor for maintaining the desired pressure in the system. Other pressure sources may be used as may be understood by those skilled in the art, provided such pressure sources are designed for transporting fluid materials through a hose or tube.

The desired pressure may be a fixed value, or may be based on the material to be pumped to the sprayer. In such an embodiment, the desired pressure may be based on the viscosity of the material within the reservoir. In an embodiment where multiple fluid materials are used, the pressure regulator may be connected to a manifold having multiple output lines, where each of the outlet lines may be connected to each reservoir, respectively. Pressure gauges may be used to monitor the pressure in the system at designated points as needed. Feedback systems may also be used as would be understood by those having ordinary skill in the art.

The reservoir holding the fluid material may be connected to the sprayer via a hose, tube or other suitable connector for transporting the fluid material. If the unit provides for application of multiple fluid materials, each such material may be held in its own reservoir, and may have its own tubing and sprayer associated with each fluid material. Optionally, a single sprayer may be connected to multiple reservoirs, where delivery of the a particular fluid material may be controlled by a valve system that only permits flow of the selected fluid material.

According to an aspect of the present invention, the sprayer may be connected to a reservoir by means of a hose or tube, with a pressure source used for drawing or pressurizing the fluid material from the reservoir through the hose or tub and to the sprayer.

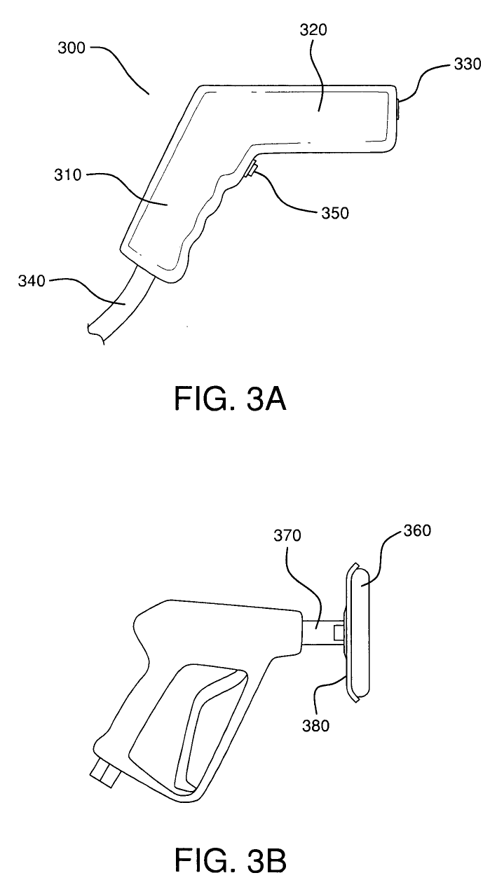

As shown in FIGS. 3A and 3B, the sprayer may be ergonomically sized and shaped such that it may be easily held and operated. For example, As shown in FIG. 3A, sprayer 300 may have a gripping portion 310 for holding sprayer 300, and further contain a barrel shaped portion 320 with an opening 330 at the far end of barrel 320 for delivery of the fluid material pumped through sprayer 300. The sprayer may be shaped as a gun, a nozzle, or any other shape desired, such that it remains practical for holding and applying a fluid material to the vehicle surface. A hose or tube 340 carrying the fluid material may be connected to sprayer 300 at the bottom surface of gripping portion 310. During the application of a fluid material, the fluid material flows from hose or tubing 340 into the bottom of the sprayer gripping portion 310. The fluid material then flows through the length of gripping portion 310 and into barrel portion 320. The fluid material then flows through the length of barrel portion 320 and exits sprayer 300 at opening 330 at the far end of barrel portion 320. The relationship of the gripping portion and the barrel portion may be any, such that the flow of fluid material is not impeded as it travels through the length of the sprayer.

Also shown in FIG. 3A, a trigger 350 may be included on the gripping portion 310 of the sprayer 300, such that when a user engages trigger 350, a valve opens and allows flow of the fluid material through sprayer 300. The trigger may be a tab, a button, a switch or any other design suitable for opening and closing a valve inside the sprayer. The trigger may also be replaced and the unit simply use the pressure of application to trigger the ejection of fluid material. In other embodiments, the head may swivel around the sprayer to more easily apply around a tire, for example.

The spray pattern of the fluid material exiting from the sprayer may be any pattern desired, and may include patterns that evenly coat an area of the targeted vehicle surface while minimizing errant spray onto non-targeted surfaces. A spray pattern adjuster (not shown) may be included at the end of the sprayer to vary the pattern according to the desire of the user. For example, nozzles of various sizes may be used to alter the spray pattern.

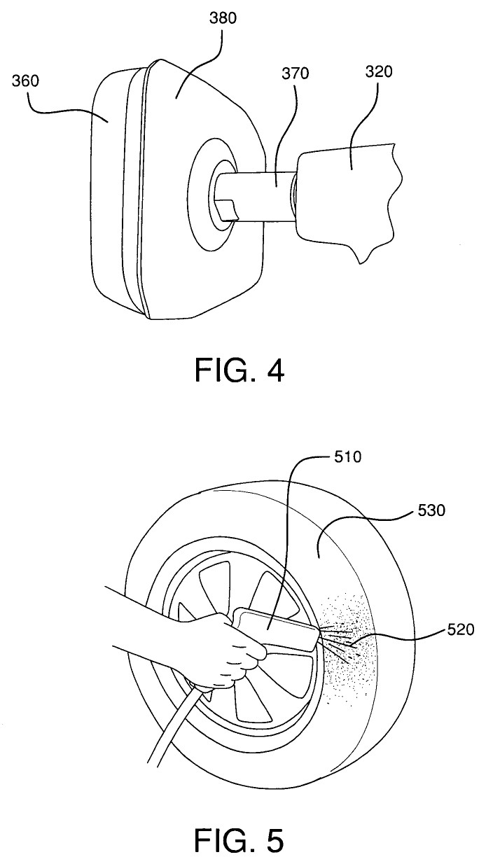

According to another aspect of the present invention and shown generally in FIG. 3B and 4, an applicator pad may be used for spreading, wiping or buffing the material applied to the vehicle surface. For example, as shown in FIG. 3B, applicator pad 360 may be any shape desired, such as square, elongated or concave. In one exemplary embodiment, the applicator pad may include a curved contact surface that may be complementary in shape with the outer curvature of a tire sidewall, or other object surface to which the applicator pad will be used.

The applicator pad may be fixedly or removably attached to the sprayer, or it may be its own hand held component, having a gripping portion and barrel portion, where the pad is situated at the far end of the barrel portion opposite the gripping portion.

In an exemplary embodiment of the present invention, when the applicator pad is attached to the sprayer, the pad may be attached to the barrel portion of the sprayer via two arms extending from the applicator pad to the attachment point on the barrel portion of the sprayer. The two arms may be adjustable in length, and may further be adjustable with relation to the barrel portion of the sprayer. For example, the two arms may swing at the attachment point to the barrel portion of the sprayer, such that the two arms and attached applicator pad may move up or down from substantially parallel from the barrel portion to substantially perpendicular to the barrel portion, or the angle of movement may be completely open, so as to allow full movement of the applicator pad in all directions until it hits resistive contact with other portions of the sprayer.

In another exemplary embodiment of the present invention, as shown in FIG. 3B, the sprayer may include a barrel extension 370 that may be secured to a backing portion 380 for applicator pad 360. A close up of this may be seen in FIG. 4. In certain embodiments, applicator pad 360 and backing portion 380 may be removably secured to barrel extension 370 as understood by those skilled in the art, such that applicator pad 360 and backing portion 380 may easily snap on and off. It should be appreciated that this removable connection would allow a user to select from a number of applicator pad types to readily snap on and off, depending on the surface to which the unit is being used. Barrel extension 370 may also spin or rotate, such that the applicator pad rotates. This rotation may optionally be controlled by an off/on switch, giving the user the ability to use the applicator pad in either a spinning function or a stationary position. The applicator pad may rotate or spin while the fluid material is also being dispensed, or when no fluid material is being dispensed.

The padded portion may be composed of any material suitable for spreading, wiping or buffing a material on a vehicle surface. For example, the padding material may be cloth, sponge, foams, or other absorbing polymers. The backing portion may be any material suitable for attachment to the two arm extensions, and for supporting the padded portion. The backing material may be rigid, or it may be flexible, such that the backing portion and padded portion may flex to meet the contours of the vehicle surface. The padded portion may be fixedly attached as understood by those skilled in the art. For example, the padded portion may be adhesively attached to the backing portion, or removably attached, such as by a velcro system.

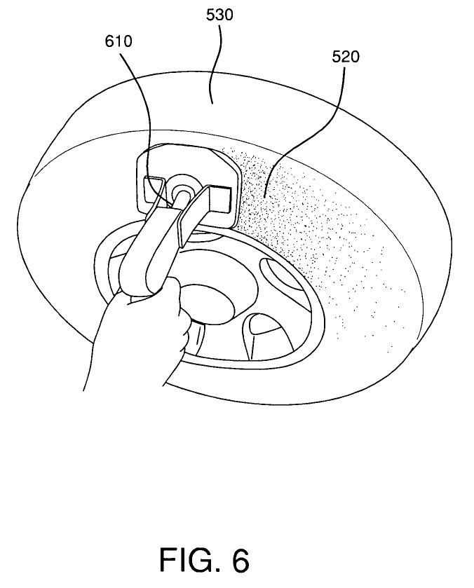

As shown generally in FIGS. 5 and 6, the unit may be used for application of a fluid material on a vehicle surface, such as a tire 530. Fluid material 520 may be applied to tire 530 via sprayer 510 or sprayer and applicator pad 610. In an alternative embodiment of the present invention, the fluid material may pass through an opening in the applicator pad when the pad is positioned over the spray opening of the sprayer. In yet another alternative embodiment, the fluid material may enter the applicator pad and be at least partially disbursed throughout the padded surface, such that the fluid material is actually applied by spreading, wiping or buffing the applicator pad on the targeted vehicle surface.

An optional holding tray may also be provided that temporarily stores the applicator between uses. The holding tray may include a cleaning solution, for removal of excess material from the applicator pad used by a previous user, such that the applicator pad does not become damaged.

Those skilled in the art will also recognize that the present invention may be described in terms of various methods. For example, the present invention may provide a method of dispensing a fluid material product comprising the steps of (a) connecting a pressure source to a reservoir containing a fluid material; (b) fluidly connecting the reservoir to a sprayer; (c) transferring at least a portion of the fluid material in the reservoir to the sprayer; (d) applying the fluid material from the sprayer to a surface of a vehicle; and (e) spreading, wiping or buffing the fluid material applied to the surface of the vehicle with an applicator pad.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A unit for applying a fluid material to a surface of a vehicle, comprising:
a body;
at least one reservoir for holding at least one fluid material;
at least one sprayer fluidly connected to the reservoir;
a pressure source suitable for creating flow of the at least one fluid material from the at least one reservoir to the at least one sprayer;
a control system for activating the pressure source to create flow upon receipt of a control signal; and
an applicator pad coupled to the sprayer for spreading, wiping or buffing the at least one fluid material on a surface of a vehicle to which the at least one fluid material is applied.

2. The unit of claim 1, wherein the pressure source comprises a venturi.

3. The unit if claim 1, wherein the pressure source comprises at least one pump.

4. The unit of claim 1, wherein the applicator pad at least partially contours to the shape of the vehicle surface to which the fluid material is applied.

5. The unit of claim 1, further comprising a nozzle coupled to the sprayer suitable for adjusting a spray pattern of the applied fluid material.

6. The unit of claim 1, wherein the applicator pad includes a channel through which the fluid material passes from the sprayer for application to the vehicle surface.

7. The unit of claim 6, wherein the fluid material is released at least partially within the applicator pad, such that the fluid material is applied to the vehicle surface by at least partially contacting the vehicle surface by the applicator pad.

8. The unit of claim 1, wherein the applicator pad is adjustably coupled to the sprayer.

9. The unit of claim 1, wherein the applicator pad is removably coupled to the sprayer.

10. The unit of claim 1, wherein the applicator pad rotates.

11. The unit of claim 1, further comprising a holding tray removably attached to the body.

12. The unit of claim 1, wherein the control system comprises a currency acceptor selected from the group consisting of a coin acceptor, bill validator, and debit or credit card reader for receipt of a payment.

13. The unit of claim 12, wherein the control signal is initiated by receipt of a payment.

14. The unit of claim 1, wherein the control system comprises a timer.

15. The unit of claim 14, wherein the timer determines the amount of time the pressure source creates flow of the at least one fluid material.

16. The unit of claim 15, wherein the control system alerts a user of the unit when the timer is substantially near expiration of time.

17. The unit of claim 15, wherein the length of time the timer designates for activation of the pressure source for creating flow of the at least one fluid material is determined by an amount of currency inserted into the unit.

18. The unit if claim 12, further comprising a menu for selecting ones of the at least one fluid material.

19. The unit of claim 18, wherein the menu is activated for selection after receipt of the payment.

20. A unit for applying a fluid material to a surface of a vehicle, comprising:
a body;
at least one reservoir for holding at least one fluid material;
at least one sprayer fluidly connected to the reservoir;
a pressure source suitable for creating flow of the at least one fluid material from the at least one reservoir to the at least one sprayer; and
a control system for activating the pressure source to create flow upon receipt of a control signal.

21. A method of applying a fluid material to a surface of a vehicle, comprising the steps of:
(a) connecting a pressure source to a reservoir containing a fluid material;
(b) fluidly connecting the reservoir to a sprayer;
(c) transferring at least a portion of the fluid material in the reservoir to the sprayer;
(d) applying the fluid material from the sprayer to a surface of a vehicle; and
(e) spreading, wiping or buffing the fluid material applied to the surface of the vehicle with an applicator pad.
